(19) United States
(12) Patent Application Publication
(10) Pub. No.: US 2024/0023613 A1
(43) Pub. Date: Jan. 25, 2024

(54) HEATER MEMBER, METHOD FOR FORMING HEATER MEMBER, AND SMOKING DEVICE

(71) Applicant: ASTLA COATING CO., LTD., Daegu (KR)

(72) Inventor: Jong-Seong GIM, Daegu (KR)

(73) Assignee: ASTLA COATING CO., LTD., Daegu (KR)

(21) Appl. No.: 18/025,261

(22) PCT Filed: Jul. 8, 2021
(86) PCT No.: PCT/KR2021/008728

§ 371 Date: Mar. 8, 2023

(30) Foreign Application Priority Data
Sep. 8, 2020 (KR) 10-2020-0114956

(51) Int. Cl. A24F 40/46; H05B 3/22; A24F 40/20; A24F 40/70

(52) U.S. Cl. CPC A24F 40/46; H05B 3/22; A24F 40/20; A24F 40/70

(57) ABSTRACT

Provided is a heating member including a base formed to radiate heat in a heat emission direction so as to heat the smoking material, and a heat emission layer that is formed to be arranged toward the heat emission direction from the base and has a thermal emissivity of 0.94 or greater.

### TECHNICAL FIELD

One or more embodiments of the present disclosure relate to a heating member, a method of manufacturing a heating member, and a device for smoking.

### RELATED ART

A heating member for heating operation is used in various fields and may be used widely in desired fields by variously designing a shape and a size of the heating member. For example, the heating member may be used in a smoking material for smoking.

For a long period of time, various kinds of smoking members have been used by people for smoking. For example, a rod-shaped cigarette may be formed and processed with a filter member to form a tobacco and to be used.

In addition, smoking members for smoking have been developed in various shapes, and a smoking member may be partially or entirely inserted in another device so as to diversify smoking environment of a user.

Such above smoking member may be generally used after coupling various structures to the smoking material, for convenience of the user. For example, a heating-type smoking member, in which a smoking material such as a cigarette formed of tobacco leaves is inserted and heated, has been suggested, and in detail, a type of an electronic tobacco has been researched and used.

The heating-type smoking member uses a method of generating smoking vapor by heating the smoking material via a heater.

In addition, when heating the smoking material, high-temperature heat is generated rapidly, and because the number of times of smoking operations increases, there is a limitation in improving durability, efficiency, and safety of the heater.

### DETAILED DESCRIPTION OF THE DISCLOSURE

### Technical Problem

One or more embodiments of the present disclosure provide a heating member capable of improving a thermal efficiency, durability, and safety, a method of manufacturing the heating member, and a smoking device.

### Technical Solution

According to an embodiment, a heating member includes a base formed to radiate heat in a heat emission direction so as to heat a smoking material, and a heat emission layer that is formed to be arranged toward the heat emission direction from the base and has a thermal emissivity of 0.94 or greater.

At least the thickness of the heat emission layer may have a value of about 2.0 μm to about 5.0 μm.

According to another embodiment, a method of forming a heating member includes: preparing a base formed to emit heat in a heat emission direction so as to heat a to-be-heated material; and forming a heat emission layer by using a deposition process, the heat radiation member being arranged toward the heat emission direction from the base and having a thermal emissivity of 0.94 or greater.

According to another embodiment, a smoking device includes: a main body; an accommodation portion that is connected to one region of the main body and formed to accommodate at least one region of the smoking material; and a heating member comprising a base that is arranged in the accommodation portion and formed to radiate heat in a heat emission direction so as to heat the smoking material, and a heat emission layer that is formed to be arranged toward the heat emission direction from the base and has a thermal emissivity of 0.94 or greater.

Other aspects, features and advantages other than those described above will become apparent from the following detailed description of the drawings, claims and disclosure.

### Advantageous Effects of Disclosure

According to a heating member, a method of manufacturing the heating member, and a smoking device of the embodiments of the present disclosure, thermal efficiency, durability, and safety may be improved.

### BRIEF DESCRIPTION OF THE DRAWINGS

FIG. 1 is a schematic cross-sectional view of a part of a heating member according to an embodiment of the present disclosure.

FIG. 2 is an enlarged view of FIG. 1.

FIG. 3 is a schematic cross-sectional view of a heating member according to another embodiment of the present disclosure.

FIG. 4 is an enlarged view of FIG. 3.

FIGS. 5 and 6 are diagrams illustrating examples of various shapes of a heat emission layer in the heating member of FIG. 3.

FIG. 7 is an optical emission photograph for describing a region in FIG. 3.

FIG. 8 is a schematic cross-sectional view showing a region of a heating member according to another embodiment of the present disclosure.

FIG. 9 is a diagram showing a modified example of FIG. 8.

FIG. 10 is a schematic cross-sectional view showing a region of a heating member according to another embodiment of the present disclosure.

FIG. 11 is a schematic cross-sectional view showing a region of a heating member according to another embodiment of the present disclosure.

FIG. 12 is a schematic diagram of a smoking device according to an embodiment of the present disclosure.

FIG. 13 is a schematic diagram of a smoking device according to another embodiment of the present disclosure.

### MODE OF DISCLOSURE

As the present disclosure allows for various changes and numerous embodiments, particular embodiments will be illustrated in the drawings and described in detail in the written description. The attached drawings for illustrating one or more embodiments are referred to in order to gain a sufficient understanding, the merits thereof, and the objectives accomplished by the implementation. However, the embodiments may have different forms and should not be construed as being limited to the descriptions set forth herein.

The embodiments will be described below in more detail with reference to the accompanying drawings. Those components that are the same or are in correspondence are rendered the same reference numeral regardless of the figure number, and redundant explanations are omitted.

While such terms as “first,” “second,” etc., may be used to describe various components, such components are not be limited to the above terms. The above terms are used only to distinguish one component from another.

An expression used in the singular encompasses the expression of the plural, unless it has a clearly different meaning in the context.

In the present specification, it is to be understood that the terms “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

It will be further understood that the terms “comprises” and/or “comprising,” when used in this specification, specify the presence of stated components, but do not preclude the presence or addition of one or more components. In addition, the terms such as “ . . . unit”, “module”, etc. provided herein indicates a unit performing at least one function or operation, and may be realized by hardware, software, or a combination of hardware and software.

Sizes of components in the drawings may be exaggerated for convenience of explanation. In other words, since sizes and thicknesses of components in the drawings are arbitrarily illustrated for convenience of explanation, the following embodiments are not limited thereto.

The x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

When a certain embodiment may be implemented differently, a specific process order may be performed differently from the described order. For example, two consecutively described processes may be performed substantially at the same time or performed in an order opposite to the described order.

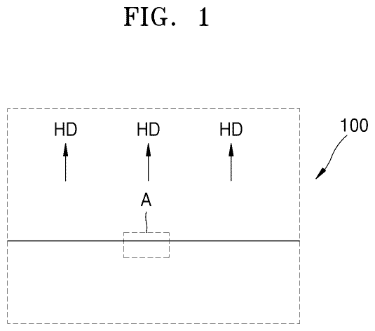

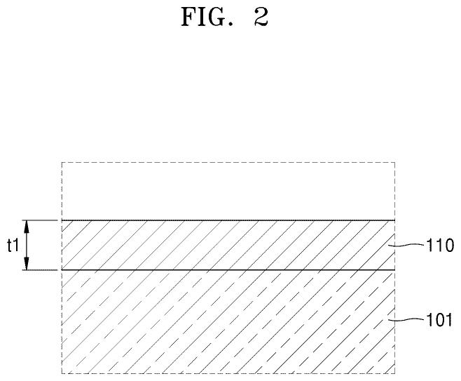

FIG. 1 is a schematic cross-sectional view of a part of a heating member according to an embodiment of the present disclosure, and FIG. 2 is an enlarged view of FIG. 1.

Referring to FIG. 1 and FIG. 2, a heating member 100 may include a base 101 and a heat emission layer 110.

As shown in FIG. 1, the heating member 100 may radiate heat in heat emission direction HD so as to heat at least a to-be-heated material (not shown), and the to-be-heated material may be adjacent to the heating member 100 in the heat emission direction HD. In addition, in an alternative embodiment, the to-be-heated material may be in contact with the heating member 100 in the heat emission direction HD.

In a detailed example, a region of a cigarette, that is, the to-be-heated material, may be adjacent to the heating member 100 in the heat emission direction HD.

A base 101 may provide heat in the heat emission direction HD, for example, may include a thermal conductive material, in a detailed example, may include metal, ceramic, or an organic material.

In an alternative embodiment, the base 101 may include tungsten, gold, platinum, silver, copper, nickel, palladium, or a combination thereof.

In another example, the base 101 may include alumina or zirconia that is a ceramic material.

The heat emission layer 110 is formed on one surface of the base 101 and may be formed to face the heat emission direction HD.

As such, thermal energy is transferred from one surface of the base 101 to the heat emission layer 110, and the transferred thermal energy is transferred to the to-be-heated material in the heat emission direction HD.

The heat emission layer 110 may be formed on at least one surface of the base 101, so as to reduce or prevent damage or deformation of the base 101 during repeated operations including heat-starting operations and heat maintaining operations through the base 101.

The heat emission layer 110 may include aluminum (Al), titanium (Ti), boron (B), and nitrogen (N).

For example, when it is defined that the heat emission layer 110 includes AlaTibBcN, a may have a value of 0.4 to 0.7, b may have a value of 0.1 to 0.4, and c may have a value of 0.01 to 0.25.

For convenience of description, a, b, and c may denote an elemental constitutional ratio of Al, Ti, and B.

In an alternative embodiment, an atomic ratio of Al/(Al+Ti) may range from to 0.7.

In an alternative embodiment, the heat emission layer 110 may include to 35 at % of titanium (Ti), 50 to 65 at % of aluminum (Al), and 1 to 25 at % of boron (B).

The heat emission layer 110 may have a thermal emissivity, for example, at least 0.94 or greater.

In an alternative embodiment, the thermal emissivity may be of 0.95 or greater, for example, the thermal emissivity may be of 0.96 to 0.98.

The thermal emissivity may be a measurement value of an efficiency of emitting or absorbing energy on a surface of a material, for example, a ratio between the thermal energy emitted from a surface of a material at a set temperature and a surface thermal energy emitted by a perfect emitter at the same set temperature. In detail, a thermal emissivity of a black body may have a value of 1.

The heat emission layer 110 of the embodiment may have a high thermal emissivity of at least 0.94, for example, 0.96 to 0.98, and thus, the thermal efficiency of the heating member 100 may be improved, and the thermal stability may be improved during a heating process by using the heating member 100.

In a detailed example, when the heating member 100 is arranged in an electronic tobacco, the emission efficiency of the thermal energy generated from the surface of the heating member 100 may be improved. In addition, the above thermal energy and the characteristics of reflecting the thermal energy from surfaces of other elements such as a wall, etc. surrounding a base material in the electronic tobacco may be controlled so that the temperature control efficiency of the electronic tobacco may be improved.

Also, the heat emission layer 110 may have a roughness value, that is, may have a surface roughness ranging from Ra 0.5 μm to Ra 1.2 μm.

As such, an easy process for controlling the thermal emissivity of the heat emission layer 110 to have the above value may be obtained, and the thermal energy reflecting characteristics from the member that may be arranged around the heating member 100, e.g., the wall, etc. in the electronic tobacco, may be precisely controlled.

The heat emission layer 110 may have a thickness t1, and the thickness t1 may have a value of about 2.0 μm to about 5.0 μm. The thickness t1 of the heat emission layer 110 may be 2.0 μm or greater so that the durability of the heat emission layer 110 against erosion, corrosion, etc. may be improved, and thus, the durability of the base 101 may be improved via the heat emission layer 110. In addition, the thickness t1 of the heat emission layer 110 may be 5.0 μm or less so that a reduction in the heat transfer characteristic from the heat emission layer 110 in the heat emission direction HD via the base 101 may be restrained.

In addition, the heat emission layer 110 may have heat-resistance, for example, a heat-resistant property of 250° C. or greater, in detail, 300° C. or greater.

Due to the material characteristics described above, the heat emission layer 110 may secure the above specific heat-resistance.

The heat emission layer 110 may be formed by various methods, for example, a vapor deposition process. In a detailed example, a physical vapor deposition (PVD) method may be performed. Also, in another example, a chemical vapor deposition (CVD), an atomic layer deposition (ALD), or a sputtering method using various conditions may be performed.

In an alternative embodiment, a surface treatment may be performed on the base 101 before forming the heat emission layer 110, and through the surface treatment, a surface roughness may be obtained on one surface of the base, 101, which faces the heat emission layer 110, and the heat emission layer 110 may be easily seated on the base 101. Also, after performing the surface treatment on the base 101, an ultrasonic cleaning process may be additionally performed, and then the heat emission layer 110 may be formed.

The heat emission layer 110 may contain the aluminum (Al), titanium (Ti), boron (B), and nitrogen (N), and a composition of a source used in forming of the heat emission layer 110 may include 10 to 35 at % of titanium (Ti), 50 to 65 at % of aluminum (Al), and 1 to 25 at % of boron (B).

A deposition process for forming the heat emission layer 110 may be performed in a chamber, and an initial pressure in the chamber may be about 10-6 Torr to about 10⁻⁵ Torr. In addition, a working pressure of coating may be about 10⁻³ Torr to 10⁻² Torr, and the inside of the chamber may be heated to 450° C. or greater.

In addition, in an alternative embodiment, an etching or cleaning process may be performed, for example, argon (Ar) gas that is a reaction gas is injected (for example, about 200 ccm), and in a coating process, nitrogen (N₂) gas may be injected, for example, 150 to 250 ccm.

During the process of forming the heat emission layer 110, the inside of the chamber may be generally heated to 450° C. or greater for activating movement of atoms of the coating material and densifying the coating layer on the surface of the base 101.

In addition, in an alternative embodiment, a cleaning and etching process is performed for foreign matters removal and surface roughness improvement on the base 101, and a bias voltage (negative bias) may be controlled within a range from 700 to 900 V.

In addition, for the purpose such as densification, crystallization structure adjustment, etc. of the heat emission layer 110, a direct current (DC) power, pulse-type voltage using the DC power, or a radio frequency (RF) power of a constant magnitude, e.g., 80 to 100 (V in biased voltage may be controlled to be applied to the base 101.

In addition, for uniform deposition of the heat emission layer 110, rotation and orbit may be executed in combination in a vacuum chamber.

A grain refining is performed due to the boron (B) contained in the heat emission layer 110, and a firm structural characteristic may be improved while improving an entire emissivity of the heating member 100.

For example, the heat emission layer 110 may have a residual compressive stress of the mechanical characteristic of about 2.0 to 3.5 GPa, in detail, about 2.7 GPa, and an elastic coefficient of 250 GPa to 350 GPa, for example, 291 GPa. Also, a hardness of the heat emission layer 110 may be 1500 Hv to 3000 Hv, for example, may have a maximum hardness of 2650 Hv.

The heating member of the embodiment may have the heat emission layer on at least one surface of the base that emits heat, and thus, the base may be effectively protected via the heat emission layer and the thermal efficiency characteristic of the heating member may be improved due to the high thermal emissivity characteristic of the heat emission layer.

Also, through the controlling of the surface characteristic of the heat emission layer, the heat reflecting characteristic from the surface of another member adjacent to the heating member, for example, the inner wall in the electronic tobacco, may be precisely controlled.

As such, the heating member according to the embodiment may easily perform the accurate control while improving the thermal characteristics. In a detailed example, when the heating member is used in a smoking device such as an electronic tobacco, etc., deformation, denaturalization, or damage of the heating member may be easily reduced even with repeated smoking operations. Also, when sensing the temperature of the heating member, distorted sensing of the temperature may be reduced or prevented, and thus, precise control of the heating member may be performed and safety of the smoking device and controlling convenience may be improved.

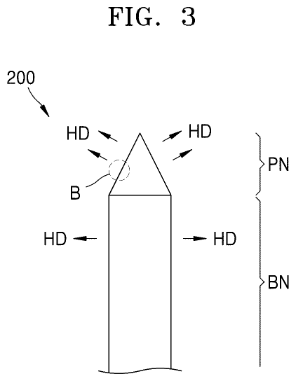

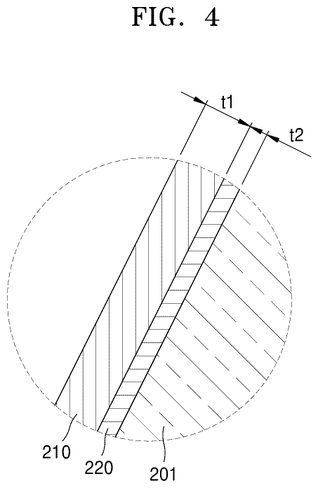

FIG. 3 is a cross-sectional view schematically showing a heating member according to another embodiment, and FIG. 4 is an enlarged view of FIG. 3.

Referring to FIGS. 3 and 4, the heating member 200 may include a base 201, a heat emission layer 210, and an adjacent control layer 220.

As shown in FIG. 3, the heating member 200 may emit heat in a heat emission direction HD so as to heat at least a to-be-heated material (not shown), and the to-be-heated material may be adjacent to the heating member 200 in the heat emission direction HD. In addition, in an alternative embodiment, the to-be-heated material may be in contact with the heating member 200 in the heat emission direction HD.

In a detailed example, a region of a cigarette, that is, the to-be-heated material, may be adjacent to the heating member 200 in the heat emission direction HD.

In an alternative embodiment, the heating member 200 may be formed in a type that is inserted in one region of a cigarette, that is, a to-be-heated material, for example, may have a base portion BN and an insertion portion PN. The insertion portion PN may have a shape, a width of which is gradually reduced toward an end, in detail, may be formed as a sharp pin shape. The heating member 200 may be easily inserted in one region of the cigarette via the insertion portion PN.

The base 201 may provide heat in the heat emission direction HD, and detailed example of the material included in the base 201 is the same as the above description or may be modified within a similar range as necessary, and thus, detailed descriptions thereof are omitted.

The heat emission layer 210 is formed on one surface of the base 201 and may be formed to face the heat emission direction HD.

As such, thermal energy is transferred from one surface of the base 201 to the heat emission layer 210, and the transferred thermal energy is transferred to the to-be-heated material in the heat emission direction HD.

The heat emission layer 210 may be formed on at least one surface of the base 201, so as to reduce or prevent damage or deformation of the base 201 during repeated heat-starting operations and heat maintaining operation through the base 201.

The heat emission layer 210 may include aluminum (Al), titanium (Ti), boron (B), and nitrogen (N). Descriptions about the components in the material of the heat emission layer 210 are the same as the above embodiment and thus are omitted.

The heat emission layer 210 may have a thermal emissivity, for example, at least 0.94 or greater.

In an alternative embodiment, the thermal emissivity may be 0.95 or greater, for example, the thermal emissivity may be between 0.96 to 0.98.

Also, the heat emission layer 210 may have a roughness value, that is, may have a surface roughness ranging from Ra 0.5 μm to Ra 1.2 μm.

The heat emission layer 210 may have the thickness t1, and the thickness t1 may have a value of about 2.0 μm to about 5.0 μm.

In addition, the heat emission layer 210 may have heat-resistance, for example, a heat-resistant property of 250° C. or greater, in detail, 300° C. or greater.

Due to the material characteristics described above, the heat emission layer 210 may secure the above specific heat-resistance.

The adjacent control layer 220 is formed on one surface of the base 201 and may be formed to face the heat emission direction HD. In detail, the adjacent control layer 220 may be formed between the base 201 and the heat emission layer 210.

The adjacent control layer 220 may be disposed between the base 201 and the heat emission layer 210 so as to improve adhesion force between the base 201 and the heat emission layer 210.

The adjacent control layer 220 may include various materials, for example, a nitride material.

In an example, the adjacent control layer 220 may include titanium nitride (TixNy) or chromium nitride (CrxNy).

The adjacent control layer 220 may have a thickness t2, and at least the thickness of the adjacent control layer 220 may be less than the thickness t1 of the heat emission layer 210.

In an alternative embodiment, the thickness t2 of the adjacent control layer 220 may have a value of 1 μm or less, for example, 0.01 μm to 0.05 μm. For example, the thickness t2 may have a value of 0.03 μm.

When the thickness t2 of the adjacent control layer 220 is less than the thickness t1 of the heat emission layer 210, the heat emission layer 210 may be easily coupled to the base 201 while reducing the influence to the heat radiating characteristic of the heat emission layer 210.

The adjacent control layer 220 and the heat emission layer 210 may be formed on the base 201 in various methods.

In a detailed example, a PVD method may be used. Also, in another example, a CVD, an ALD, or a sputtering method using various conditions may be performed.

In an alternative embodiment, before forming the adjacent control layer 220 on the base 201, a surface treatment may be performed on the base 201, and the descriptions thereof are the same as or may be modified from the above descriptions in the previous embodiment and are omitted.

The adjacent control layer 220 may be formed by performing a deposition by using titanium or chrome as a source.

The heat emission layer 210 may contain aluminum (Al), titanium (Ti), boron (B), and nitrogen (N), and may be manufactured by various methods. For example, one of the above-described methods may be used, and thus, detailed descriptions thereof are omitted.

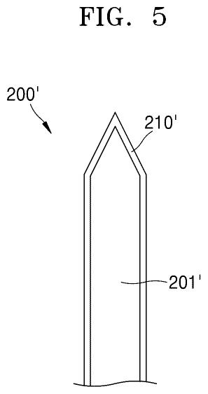

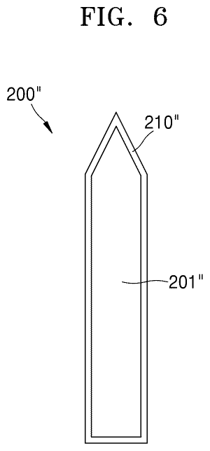

FIGS. 5 and 6 are diagrams illustrating examples of various shapes of a heat emission layer in the heating member of FIG. 3.

Referring to FIG. 5, a heat emission layer 210′ of a heating member 200′ may be formed to cover at least one surface of a base 201′, for example, may cover a region corresponding to an end portion including a sharp insertion portion of the base 201′, and then may extend to the side surface of the base 201′.

Also, in another example, referring to FIG. 6, a heat emission layer 210″ of a heating member 200″ may be formed to cover side and lower surfaces of a base 201″, for example, may be formed to surround outer surfaces of the base 201″.

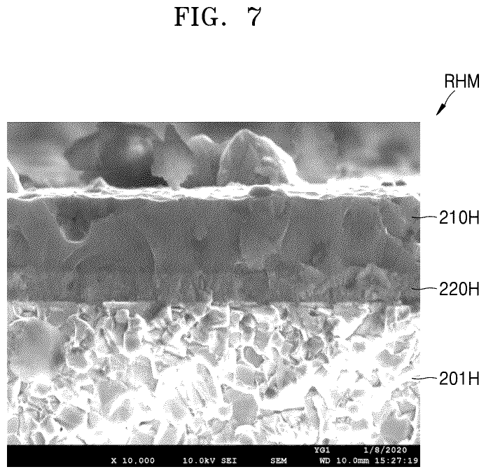

FIG. 7 is an optical radiation photograph for describing a region in FIG. 3. Referring to FIG. 7, a cross-section of a region in the heating member 200 of FIG. 3 is shown, for example, an optical micrograph RHM may be shown.

The optical micrograph RHM may include a base picture 201H showing the base 201, an adjacent control layer picture 220H showing the adjacent control layer 220, and a heat emission layer picture 210H showing the heat emission layer 210.

It is shown that the heat emission layer 210 and the base 201 may be stably bonded to each other via the adjacent control layer 220.

TABLE 1

| | | | | | |
|---|---|---|---|---|---|
| sample | time | bias (V) | nitrogen | Al/(Al + Ti) | coated |

| | TiAlN | AlTiN | AlTiSiN | AlTiBN |
|---|---|---|---|---|
| surface | 0.038 | 0.025 | 0.038 | 0.092 |
| roughness Ra | | | | |
| (um) | | | | |
| emissivity | 0.68 | 0.75 | 0.50 | 0.87 |

| | | | | | thickness |
|---|---|---|---|---|---|
| | (min.) | | (ccm) | | (um) |
| TiAlN | 120 | 80-100 | 200 | 0.5 | 2.7 |
| AlTiN | 120 | 80-100 | 250 | 0.67 | 3.0 |
| AlTiSiN | 130 | 80 | 250 | 0.68 | 2.8 |
| AlTiBN | 140 | 80 | 250 | 0.7 | 2.7 |

Table 1 above represents a process of preparing various samples, for exemplarily identifying the characteristics of the heat emission layer 210 according to the embodiment. Here, the heat emission layer 210 may correspond to AITiBN of Table 1.

In order to measure an emissivity from the sample of Table 1 above, the emissivity was measured under a condition with a region having a wavelength of 1.5 to 1.8 μm, a process response time of 50 ms, a measurement field diameter of 290 mm to 1.5 mm, and a temperature output signal of 4 to 20 mA by using a pyrometer for optical use.

[Table 2]

Table 2 above represents emissivity values at a temperature of 400° C. for each surface roughness with respect to each sample shown in Table 1 above. Referring to Table 2, AITiBN corresponding to the heat emission layer 210 has the highest value of thermal emissivity.

TABLE 3

| | AlTiN | AlTiN | AlTiBN | AlTiBN |
|---|---|---|---|---|
| Surface | 0.57 | 0.61 | 0.53 | 0.91 |
| roughness Ra | | | | |
| (um) | | | | |
| Emissivity | 0.87 | 0.93 | 0.96 | 0.98 |

Table 3 above shows an emissivity value at the temperature of 400° C. for each surface roughness with respect to each sample in Table 1. In detail, Table 3 shows higher surface roughness than that of Table 2. Referring to Table 3 above, the thermal emissivity of AITiBN corresponding to the heat emission layer 210 has the highest value, for example, the thermal emissivity has a value of 0.98 when the surface roughness is 0.91.

The heating member of the embodiment may have the heat emission layer on at least one surface of the base that radiates heat, and thus, the base may be effectively protected via the heat emission layer and the thermal efficiency characteristic of the heating member may be improved due to the high thermal emissivity characteristic of the heat emission layer.

Also, through the controlling of the surface characteristic of the heat emission layer, the heat reflecting characteristic from the surface of another member adjacent to the heating member, for example, the inner wall in the electronic tobacco, may be precisely controlled.

As such, the heating member according to the embodiment may easily perform the precise control while improving the thermal characteristics. In a detailed example, when the heating member is used in a smoking device such as the electronic tobacco, etc., deformation, denaturalization, or damage of the heating member may be easily reduced even with repeated smoking operations. Also, when sensing the temperature of the heating member, distorted sensing of the temperature may be reduced or prevented, and thus, precise control of the heating member may be possible and safety of the smoking device and controlling convenience may be improved.

Also, the adjacent control layer is formed between the heat emission layer and the base so as to improve the coupling force characteristic between the base and the heat emission layer, and thus, isolation of the heat emission layer from the heating member or damage to the heat emission layer may be easily reduced, thereby improving durability of the heating member.

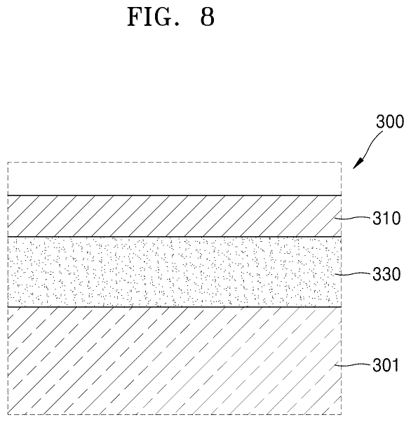

FIG. 8 is a schematic cross-sectional view showing a region of a heating member according to another embodiment of the present disclosure.

Referring to FIG. 8, the heating member 300 may include a base 301, a heat emission layer 310, and a composition gradient layer 330.

The base 301 may provide heat in the heat emission direction, and detailed example of the material included in the base 301 is the same as the above description or may be modified within a similar range as necessary, and thus, detailed descriptions thereof are omitted.

The heat emission layer 310 is formed on one surface of the base 301 and may be formed to face the heat emission direction.

As such, thermal energy is transferred from one surface of the base 301 to the heat emission layer 310, and the transferred thermal energy is transferred to the to-be-heated material in the heat emission direction.

The heat emission layer 310 may be formed on at least one surface of the base 301, so as to reduce or prevent damage or deformation of the base 301 during the repeated operations including heat-starting operations and heat maintaining operations through the base 301.

The heat emission layer 310 may include aluminum (Al), titanium (Ti), boron (B), and nitrogen (N). Descriptions about the components in the material of the heat emission layer 310 are the same as the above embodiment and thus are omitted.

The heat emission layer 310 may have a thermal emissivity, for example, a thermal emissivity of at least 0.94 or greater.

In an alternative embodiment, the thermal emissivity may be 0.95 or greater, for example, the thermal emissivity may be between 0.96 to 0.98.

Also, the heat emission layer 310 may have a roughness value, that is, may have a surface roughness ranging from Ra 0.5 μm to 1.2 μm.

The heat emission layer 310 may have the thickness t1, and the thickness t1 may have a value of about 2.0 μm to about 5.0 μm.

In addition, the heat emission layer 310 may have heat-resistance, for example, a heat-resistant property of 250° C. or greater, in detail, 300° C. or greater.

Due to the material characteristics described above, the heat emission layer 310 may secure the above specific heat-resistance.

The composition gradient layer 330 may be formed on one surface of the base 301, in detail, may be formed between the base 301 and the heat emission layer 310.

The composition gradient layer 310 may have elements that are the same as or similar to those of the heat emission layer 310. For example, the composition gradient layer 330 may include aluminum (Al), titanium (Ti), boron (B), and nitrogen (N).

For example, when it is defined that the composition gradient layer 330 includes AlaTibBcN, a may have a value of 0.4 to 0.7, b may have a value of 0.1 to 0.4, and c may have a value of 0.01 to 0.25.

For convenience of description, a, b, and c may denote elemental constitutional ratios of Al, Ti, and B.

In an alternative embodiment, an atomic ratio of Al/(Al+Ti) may range from 0.6 to 0.7.

In the composition gradient layer 330, a composition value of each element may gradually change in a thickness direction of the composition gradient layer 330, for example, a direction from the base 301 to the heat emission layer 310.

In an alternative embodiment, toward the heat emission layer 310 from the base 301, a composition value of each element, in detail, Aluminum (Al), titanium (Ti), boron (B), and nitrogen (N), in the composition gradient layer 330 may be gradually changed so as to have a similar value to that of the heat emission layer 310.

Through the composition gradient layer 330, the composition in the region adjacent to the base 301 is controlled to improve adhesion force to the base 301, and the composition in the region adjacent to the heat emission layer 310 is controlled to have the composition that is similar to or the same as the heat emission layer 310. Thus, the characteristics of the heat emission layer 310 may be improved while maintaining the thickness of the heat emission layer 310 to a desired level and the coupling force to the base 301 may be improved.

The composition gradient layer 330 may have a thickness that may have at least a value greater than the thickness of the heat emission layer 310.

The composition gradient layer 330 has the composition gradient, in which the composition is gradually changed. Also, in a detailed example, with respect to the same element as that of the heat emission layer 310, a compositional ratio among the respective elements is changed according to the thickness, and thus, the durability may be improved while securing the thickness of the layer formed on the base 301 and restraining the reduction in the heat emission characteristic.

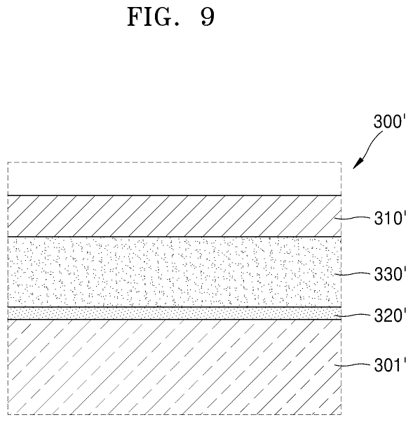

FIG. 9 is a diagram showing a modified example of FIG. 8.

Referring to FIG. 9, a heating member 300′ may include a base 301′, a heat emission layer 310′, an adjacent control layer 320′, and a composition gradient layer 330′.

The base 301′ may provide heat in the heat emission direction, and detailed example of the material included in the base 301 is the same as the above description or may be modified within a similar range as necessary, and thus, detailed descriptions thereof are omitted.

The heat emission layer 310′ is formed on one surface of the base 301′ and may be formed to face the heat emission direction.

The adjacent control layer 320′ is formed on one surface of the base 301′ and may be formed to face the heat emission direction. In detail, the adjacent control layer 320′ may be formed between the base 301′ and the composition gradient layer 330′, and detailed descriptions thereof are the same as those of the above embodiment or may be modified within a similar range as necessary, and thus, are omitted.

The composition gradient layer 330′ may be formed on one surface of the base 301′, and in particular, may be formed between the adjacent control layer 320′ and the heat emission layer 310′.

Detailed descriptions about the composition gradient layer 330′ are the same as those of the above embodiment or may be modified within a similar range as necessary, and thus, are omitted.

The heating member of the embodiment may have the heat emission layer on at least one surface of the base that radiates heat, and thus, the base may be effectively protected via the heat emission layer and the thermal efficiency characteristic of the heating member may be improved due to the high thermal emissivity characteristic of the heat emission layer.

Also, through the controlling of the surface characteristic of the heat emission layer, the heat reflecting characteristic from the surface of another member adjacent to the heating member, for example, the inner wall in the electronic tobacco, may be precisely controlled.

As such, the heating member according to the embodiment may easily perform the precise control while improving the thermal characteristics. In a detailed example, when the heating member is used in a smoking device such as an electronic tobacco, etc., deformation, denaturalization, or damage of the heating member may be easily reduced even with repeated smoking operations. Also, when sensing the temperature of the heating member, distorted sensing of the temperature may be reduced or prevented, and thus, precise control of the heating member may be possible and safety of the smoking device and controlling convenience may be improved.

Also, the composition gradient layer having the same or similar elements as/to those of the heat emission layer and having the composition ratio that is gradually changed according to the thickness may be formed between the heat emission layer and the base. As such, it is easy to secure an appropriate thickness value of the heat emission layer and the composition gradient layer having similar characteristic to the heat emission layer on the base, and thus, isolation of the upper portion of the base may be reduced or prevented and the durability of the heating member may be improved. Also, the composition ratio is controlled according to the thickness, so that the coupling force to the base is improved in the region adjacent to the base. In addition, the similar composition ratio to that of the heat emission layer is obtained in the region adjacent to the heat emission layer, and thus, the stabilized interfacial coupling characteristic with the heat emission layer may be improved.

Also, the adjacent control layer is formed between the composition gradient layer and the base so as to improve the coupling force characteristic between the base and the composition gradient layer, and thus, isolation of the composition gradient layer and the heat emission layer from the heating member or damage to the heat emission layer and the composition gradient layer may be easily reduced, thereby improving durability of the heating member.

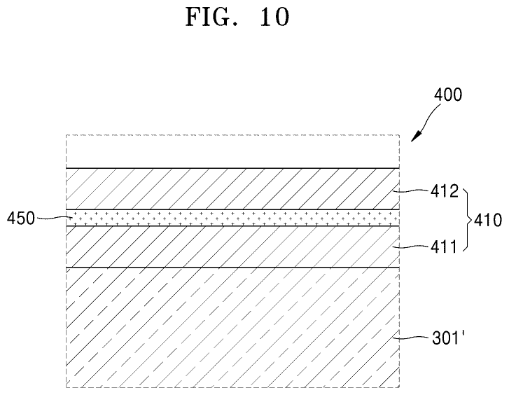

FIG. 10 is a schematic cross-sectional view showing a region of a heating member according to another embodiment of the present disclosure.

Referring to FIG. 10, a heating member 400 may include a base 401, a heat emission layer 410, and an intermediate layer 450.

The base 401 may provide heat in the heat emission direction, and detailed example of the material included in the base 401 is the same as the above description or may be modified within a similar range as necessary, and thus, detailed descriptions thereof are omitted.

The heat emission layer 410 is formed on one surface of the base 401 and may be formed to face the heat emission direction.

As such, thermal energy is transferred from one surface of the base 401 to the heat emission layer 410, and the transferred thermal energy is transferred to the to-be-heated material in the heat emission direction.

The heat emission layer 410 may be formed on at least one surface of the base 401, so as to reduce or prevent damage or deformation of the base 401 during repeated operations including heat-starting operations and heat maintaining operations through the base 401.

The heat emission layer 410 may include a plurality of emission layers 411 and 412 that are spaced apart from each other.

In detail, the heat emission layer 410 may include a first emission layer 411 and a second emission layer 412, which are spaced apart from each other based on a direction away from the base 401.

The first emission layer 411 and the second emission layer 412 of the heat emission layer 410 may each contain aluminum (Al), titanium (Ti), boron (B), and nitrogen (N), and descriptions about each component are the same as those of the above embodiment and are omitted.

The intermediate layer 450 may be disposed between the first emission layer 411 and the second emission layer 412.

The intermediate layer 450 may contain different materials from those of the first emission layer 411 and the second emission layer 412, for example, the intermediate layer 450 may include aluminum (Al), titanium (Ti), and nitrogen (N).

The intermediate layer 450 may be defined as AlaTibN in a formula expressing composition. Here, a+b is 1, an atomic ratio of Al/(Al+Ti) is 0.6 to 0.7, a has a value of 0.4 to 0.7, and b has a value of 0.1 to 0.4.

The intermediate layer 450 may have a thickness that may be less than that of the first emission layer 411 or that of the second emission layer 412 in the heat emission layer 410. The intermediate layer 450 is formed between the first emission layer 411 and the second emission layer 412 so as to reduce the residual stress generated when forming the first emission layer 411 and the second emission layer 412, and to improve the total durability of the heating member 400.

The thickness of the intermediate layer 450 may correspond to, for example, 0.4 to 0.6 of the thickness of the first emission layer 411 or 0.4 to 0.6 of the thickness of the second emission layer 412 in the heat emission layer 410, and in particular, may have a value corresponding to 0.5 of the thickness.

The heating member of the embodiment may have the heat emission layer on at least one surface of the base that radiates heat, and thus, the base may be effectively protected via the heat emission layer and the thermal efficiency characteristic of the heating member may be improved due to the high thermal emissivity characteristic of the heat emission layer.

Also, through the controlling of the surface characteristic of the heat emission layer, the heat reflecting characteristic from the surface of another member adjacent to the heating member, for example, the inner wall in the electronic tobacco, may be precisely controlled.

As such, the heating member according to the embodiment may easily perform the precise control while improving the thermal characteristics. In a detailed example, when the heating member is used in a smoking device such as an electronic tobacco, etc., deformation, denaturalization, or damage of the heating member may be easily reduced even with repeated smoking operations. Also, when sensing the temperature of the heating member, distorted sensing of the temperature may be reduced or prevented, and thus, precise control of the heating member may be possible and safety of the smoking device and controlling convenience may be improved.

Also, when forming the heat emission layer, the first and second emission layers that are spaced apart from each other are formed, and then, the intermediate layer may be formed therebetween. As such, the stress that may remain when securing the entire thickness of the heat emission layer may be reduced, and thus, the durability of the heating member may be entirely improved.

Also, although not shown in the drawings, an adjacent control layer may be formed between the first emission layer and the base so as to improve the coupling force characteristic between the base and the first emission layer.

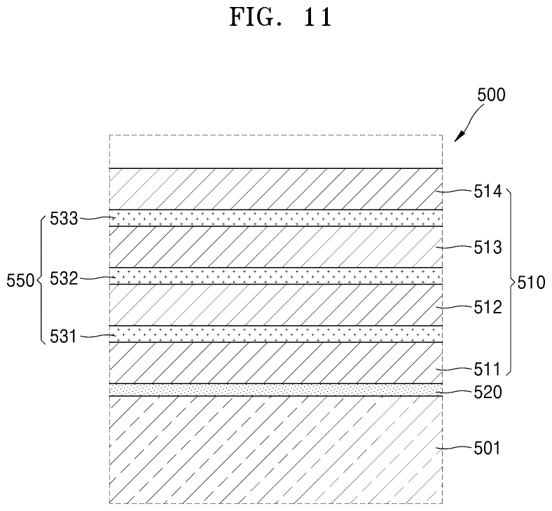

FIG. 11 is a schematic cross-sectional view showing a region of a heating member according to another embodiment of the present disclosure.

Referring to FIG. 11, a heating member 500 may include a base 501, a heat emission layer 510, and an intermediate layer 550.

The base 501 may provide heat in the heat emission direction, and detailed example of the material included in the base 401 is the same as the above description or may be modified within a similar range as necessary, and thus, detailed descriptions thereof are omitted.

The heat emission layer 510 is formed on one surface of the base 501 and may be formed to face the heat emission direction.

As such, thermal energy is transferred from one surface of the base 501 to the heat emission layer 510, and the transferred thermal energy is transferred to the to-be-heated material in the heat emission direction.

The heat emission layer 510 may be formed on at least one surface of the base 501, so as to reduce or prevent damage or deformation of the base 501 during repeated operations including heat-starting operations and heat maintaining operation through the base 501.

The heat emission layer 510 may include a plurality of emission layers that are spaced apart from each other.

In a detailed example, the heat emission layer 510 may include a first emission layer 511, a second emission layer 512, a third emission layer 513, and a fourth emission layer 514, which are spaced apart from one another based on the direction away from the base 501.

FIG. 11 shows that the heat emission layer 510 includes four layers, but the embodiment is not limited thereto, and the number of layers may vary depending on a required characteristic or a design condition.

The first emission layer 511, the second emission layer 512, the third emission layer 513, and the fourth emission layer 514 of the heat emission layer 510 may each contain aluminum (Al), titanium (Ti), boron (B), and nitrogen (N), and because each component is described above with reference to the previous embodiment, detailed descriptions thereof are omitted.

The adjacent control layer 520 is formed on one surface of the base 501 and may be formed to face the heat emission direction. In detail, the adjacent control layer 520 may be formed between the base 501 and the heat emission layer 510, and for example, the adjacent control layer 520 may be formed between the base 501 and the first emission layer 511.

Detailed descriptions about the material included in the adjacent control layer 520, etc. are the same as those of the above embodiment or may be modified within a similar range as necessary, and thus, are omitted.

The intermediate layer 550 may include one or more layers to be disposed among the plurality of emission layers in the heat emission layer 510. In a detailed example, the intermediate layer 550 may include a first intermediate layer 551, a second intermediate layer 552, and a third intermediate layer 553, and in an alternative embodiment, the layers may be spaced apart from one another.

The first intermediate layer 551 may be disposed between the first emission layer 511 and the second emission layer 512, the second intermediate layer 552 may be disposed between the second emission layer 512 and the third emission layer 513, and the third intermediate layer 553 may be disposed between the third emission layer 513 and the fourth emission layer 514.

The intermediate layer 550 may include different materials from those of the first emission layer 511, the second emission layer 512, the third emission layer 513, and the fourth emission layer 514 of the heat emission layer 510, for example, the first intermediate layer 551, the second intermediate layer 552, and the third intermediate layer 553 of the intermediate layer 550 may contain aluminum (Al), titanium (Ti), and nitrogen (N).

The first, second, and third intermediate layers 551, 552, and 553 of the intermediate layer 550 may be defined as AlaTibN in a formula expressing the composition. Here, a+b may be 1, an atomic ratio of Al/(Al+Ti) may be 0.6 to 0.7, a may have a value of 0.4 to 0.7, and b may have a value of 0.1 to 0.4.

Each of the first, second, and third intermediate layers 551, 552, and 553 of the intermediate layer 550 may have a thickness that may be less than that of the first, second, third, and fourth emission layers 511, 512, 513, and 514 of the heat emission layer 510. Each of the first, second, and third intermediate layers 551, 552, and 553 of the intermediate layer 550 may be formed between the first, second, third, and fourth emission layers 511, 512, 513, and 514, so as to reduce the residual stress that occurs when forming the first, second, third, and fourth emission layers 511, 512, 513, and 514. Thus, the total thickness of the emission layer 510 may be increased and the durability of the heating member 500 may be maintained or increased.

The thickness of each of the first, second, and third intermediate layers 551, 552, and 553 of the intermediate layer 550 may correspond to 0.4 to 0.6 of the thickness of each of the first, second, third, and fourth emission layers 511, 512, 513, and 514 of the heat emission layer 510, for example, 0.5.

The heating member of the embodiment may have the heat emission layer on at least one surface of the base that radiates heat, and thus, the base may be effectively protected via the heat emission layer and the thermal efficiency characteristic of the heating member may be improved due to the high thermal emissivity characteristic of the heat emission layer.

Also, through the controlling of the surface characteristic of the heat emission layer, the heat reflecting characteristic from the surface of another member adjacent to the heating member, for example, the inner wall in the electronic tobacco, may be precisely controlled.

As such, the heating member according to the embodiment may easily perform the precise control while improving the thermal characteristics. In a detailed example, when the heating member is used in a smoking device such as the electronic tobacco, etc., deformation, denaturalization, or damage of the heating member may be easily deduced even with repeated smoking operations. Also, when sensing the temperature of the heating member, distorted sensing of the temperature may be reduced or prevented, and thus, precise control of the heating member may be possible and safety of the smoking device and controlling convenience may be improved.

Also, when forming the heat emission layer, the first and second emission layers that are spaced apart from each other are formed, and then, the intermediate layer may be formed therebetween. As such, the stress that may remain when securing the entire thickness of the heat emission layer may be reduced, and thus, the durability of the heating member may be entirely improved.

Also, an adjacent control layer may be formed between the first emission layer and the base so as to improve the coupling force characteristic between the base and the first emission layer.

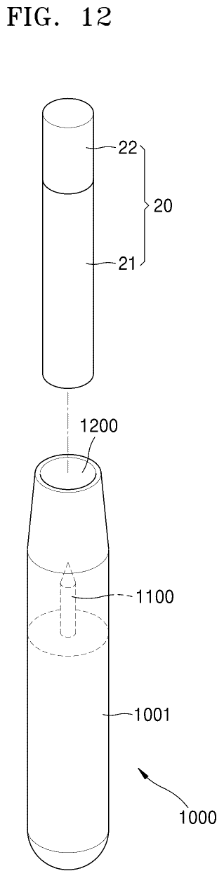

FIG. 12 is a schematic diagram of a smoking device according to an embodiment of the present disclosure.

Referring to FIG. 12, a smoking device 1000 may include a main body 1001 and an accommodation portion 1200, and a heating member 1100 may be disposed in an inner space of the accommodation portion 1200.

A smoking material 20 such as a cigarette is accommodated in the accommodation portion 1200, and then, the heating member 1100 may be inserted in an end portion of the smoking material 20. In a detailed example, the heating member 1100 may be inserted in and applies heat to one end of an aerosol generating material 21 of the smoking material 20, and the aerosol generated by the aerosol generating material 21 may be transferred to a user via a filter 22.

Here, the heating member 1100 may be one of the heating members described above in the previous embodiments.

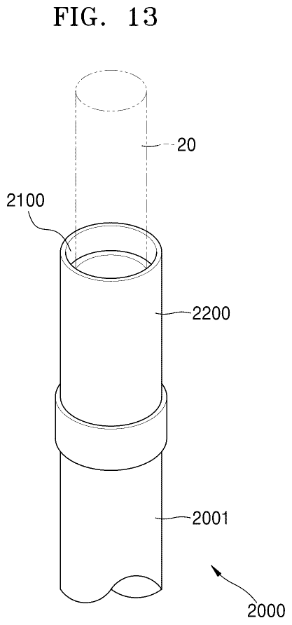

FIG. 13 is a schematic diagram of a smoking device according to another embodiment of the present disclosure.

Referring to FIG. 13, a smoking device 2000 may include a main body 2001 and an accommodation portion 2200, and a heating member 2100 may be disposed in an inner space of the accommodation portion 2200.

The smoking material 20 such as a cigarette may be accommodated in the accommodation portion 2200 to be adjacent to the heating member 2100, for example, the smoking material 20 may be inserted in the inner space of the heating material 2100 so that the heating member 2100 surrounds the smoking material 20.

Here, the heating member 2100 may be one of the heating members described above in the previous embodiments.

The smoking device of the embodiment may include the heating member according to the previous embodiments, and accordingly, when the heating member operates for user's smoking, the thermal emissivity characteristic may be improved so that the thermal efficiency may be improved. In addition, the heating member may be precisely controlled so as to improve safety of the smoking device and improve the precise smoking control characteristic.

Also, through the stabilized formation of the heating member, the durability of the heating member and the smoking device including the heating member may be improved.

Also, the smoking convenience of the user may be improved according to the precise control of the heating member.

While the disclosure has been particularly shown and described with reference to exemplary embodiments thereof, it will be understood by those of ordinary skill in the art that various changes in form and details may be made therein without departing from the spirit and scope as defined by the following claims. Therefore, the scope sought to be protected of the disclosure shall be defined by the appended claims.

The particular implementations shown and described herein are illustrative examples of the embodiments and are not intended to otherwise limit the scope of the embodiments in any way. Moreover, no item or component is essential to the practice of the disclosure unless the element is specifically described as “essential” or “critical”.

The singular forms “a,” “an” and “the” in the specification of the embodiments, in particular, claims, may be intended to include the plural forms as well. Unless otherwise defined, the ranges defined herein is intended to include values within the range as individually applied and may be considered to be the same as individual values constituting the range in the detailed description. Finally, operations constituting methods may be performed in appropriate order unless explicitly described in terms of order or described to the contrary. Exemplary embodiments are not necessarily limited to the order of operations given in the description. The examples or exemplary terms (for example, etc.) used herein are to merely describe exemplary embodiments in detail are not intended to limit the embodiments unless defined by the following claims. Also, those of ordinary skill in the art will readily appreciate that many alternations, combinations and modifications, may be made according to design conditions and factors within the scope of the appended claims and their equivalents.

On the other hand, embodiments of the disclosure described above may be implemented in a general purpose digital computer to be written as a program that may be executed on a computer, and operate the programs using a computer readable recording medium. In addition, the structure of the data used in the above-described method may be recorded on a computer-readable recording medium through various means. Examples of the computer readable recording medium include magnetic storage media (e.g., ROM, RAM, USB drives, floppy disks, hard disks, etc.), optical recording media (e.g., CD-ROMs, or DVDs), etc.

### INDUSTRIAL APPLICABILITY

As the present disclosure allows for various changes and numerous embodiments, particular embodiments will be illustrated in the drawings and described in detail in the written description. The attached drawings for illustrating one or more embodiments are referred to in order to gain a sufficient understanding, the merits thereof, and the objectives accomplished by the implementation. However, the embodiments may have different forms and should not be construed as being limited to the descriptions set forth herein.

1. A heating member comprising:
a base formed to emit heat in a heat emission direction so as to heat a to-be-heated material; and
a heat emission layer that is formed to be arranged in a direction toward the heat emission direction from the base, and has a thermal emissivity of 0.94 or greater.

2. The heating member of claim 1, wherein
at least the thickness of the heat emission layer has a value of about 2.0 μm to about 5.0 μm.

3. A method of forming a heating member, the method comprising:
preparing a base formed to emit heat in a heat emission direction so as to heat a to-be-heated material; and
forming a heat emission layer by using a deposition process, the heat radiation member being arranged toward the heat emission direction from the base and having a thermal emissivity of 0.94 or greater.

4. A smoking device comprising:
a main body;
an accommodation portion that is connected to one region of the main body and formed to accommodate at least one region of a smoking material; and
a heating member comprising a base that is arranged in the accommodation portion and formed to radiate heat in a heat emission direction so as to heat the smoking material, and a heat emission layer that is formed to be arranged toward the heat emission direction from the base and has a thermal emissivity of 0.94 or greater.
